(19) United States
(12) Patent Application Publication
(10) Pub. No.: US 2014/0295240 A1
(43) Pub. Date: Oct. 2, 2014

(54) BATTERY DEVICE

(71) Applicants: KYOHO MACHINE WORKS, LTD., Toyota-shi (JP); TOYODA GOSEI CO., LTD., Kiyosu-shi (JP)

(72) Inventors: Shinichi TAKEDA, Kiyosu-shi (JP); Jin KASUYA, Kiyosu-shi (JP); Yoshiaki KAMEDA, Kiyosu-shi (JP); Kosuke KUSABA, Kiyosu-shi (JP); Masanori KODERA, Toyota-shi (JP); Yukihiro ISOGAI, Toyota-shi (JP); Kazuhiro NORO, Toyota-shi (JP); Nobuyoshi FUJIWARA, Toyota-shi (JP)

(73) Assignees: KYOHO MACHINE WORKS, LTD., Toyota-shi (JP); TOYODA GOSEI CO., LTD., Kiyosu-shi (JP)

(21) Appl. No.: 14/209,012

(22) Filed: Mar. 13, 2014

(30) Foreign Application Priority Data
Mar. 27, 2013 (JP) 2013-65938

(51) Int. Cl. H01M 2/20; H01M 10/65

(52) U.S. Cl. CPC H01M 2/202; H01M 10/5034; H01M 2/204; H01M 2/206
USPC 429/120; 429/158

(57) ABSTRACT

A battery device includes a bus bar having a coupling bus bars, a positive electrode bus bar and a negative electrode bus bar. The coupling bus bar includes: a positive electrode connection member arranged to sequentially connect positive electrode terminals of the respective batteries included in one battery array group; and a negative electrode connection member arranged to sequentially connect negative electrode surfaces of the respective batteries included in another battery array group. The positive electrode connection member is electrically connected with the negative electrode connection member. The positive electrode bus bar is arranged to sequentially connect specific positive electrode terminals in a specific battery array group, which are not connected by the coupling bus bar. The negative electrode bus bar is arranged to sequentially connect specific negative electrode terminals in a specific battery array group, which are not connected by the coupling bus bar.

### CROSS-REFERENCE TO RELATED APPLICATION

The present application claims priority from Japanese patent application P2013-65938 filed on Mar. 27, 2013, the entirety of disclosures of which is hereby incorporated by reference into this application.

### BACKGROUND

1. Technical Field

The invention relates to a battery device.

2. Related Art

In one known technology described in, for example, JP H09-306447A, a battery holder for holding a plurality of cylindrical batteries is configured to arrange corrugated partition plates between battery arrays consisting of a plurality of batteries, so as to transfer heat between the respective batteries. Deterioration of the battery performance depends upon a temperature variation. In the battery holder, when one battery reaches the end of the life, the other batteries are also discarded. The large temperature difference between adjacent batteries accordingly increases the number of batteries in the battery holder, which are discarded without reaching the end of the life. Heat transfer between the adjacent batteries via the partition plates equalizes the temperatures of the batteries as a whole and extends the entire life of the batteries.

In another known technology described in, for example, JP 2011-49013A, a battery holder is configured to hold the respective edges of a plurality of batteries by multi-stage blocks and to additionally arrange radiator plates between the batteries.

### SUMMARY

These known configurations of the battery holders described in JP H09-306447A and JP 2011-49013A, however, need a large number of partition plates (radiator plates) to transfer heat between the respective batteries and a large number of bus bars to connect the respective electrode terminals of the plurality of batteries. This causes a problem of increasing the total number of components. Another problem is that the partition plates interfere with arrangement of the bus bars to connect the terminal of the batteries. Additionally, the partition plates increase the overall weight of the battery holder and interfere with weight reduction.

In order to solve at least part of the problems described above, the invention may be implemented by the following aspects.

According to one aspect of the invention, there is provided a battery device provided with a bus bar. In the battery device, a plurality of battery array groups are arranged in parallel to one another, and each of the battery array groups includes a plurality of batteries arranged in an array, wherein each of the batteries has a positive electrode terminal provided on an end face of a battery casing and a negative electrode surface provided on a side face of the battery casing which is extended from an outer periphery of the end face of the battery casing. The bus bar comprises: a coupling bus bar including: a positive electrode connection member arranged to connect the positive electrode terminals of the respective batteries included in one battery array group; and a negative electrode connection member arranged to connect the negative electrode surfaces of the respective batteries included in another battery array group adjacent to the one battery array group, wherein the positive electrode connection member is electrically connected with the negative electrode connection member; a positive electrode bus bar including: a positive electrode connecting member arranged to connect specific positive electrode terminals in a specific battery array group, which are not connected by the coupling bus bar; and an external terminal connected with the positive electrode connecting member; and a negative electrode bus bar including: a negative electrode connecting member arranged to connect specific negative electrode surfaces in a specific battery array group, which are not connected by the coupling bus bar; and an external terminal connected with the negative electrode connecting member. In the battery device of this aspect, the coupling bus bar included in the bus bar is arranged to pass across battery array groups, so as to connect the positive electrode terminals of the batteries in one battery array group and connect the negative electrode terminals in another battery array group. A plurality of the coupling bus bars arranged across a plurality of battery array groups accordingly connect the respective batteries in a battery array group in parallel and connect the battery array groups in series. This arrangement simplifies the wiring operation for the plurality of batteries. The negative electrode connection member of the coupling bus bar is arranged to connect the negative electrode surfaces in a battery array group, so as to transfer heat between the respective electrodes in the battery array group and equalize the temperatures of the batteries. The negative electrode connecting member of the negative electrode bus bar is arranged to connect the negative electrode surfaces in a battery array group, so as to transfer heat between the respective electrodes in the battery array group and equalize the temperatures of the batteries. The positive electrode connecting member of the positive electrode bus bar is arranged to connect the positive electrode terminals of the batteries and transfer heat between the batteries, so as to equalize the temperatures of the batteries. The bus bar accordingly serves to uniform the heat of the batteries, thus preventing thermal deterioration of only part of the batteries and extending the life of the batteries. The additional function of the bus bar to uniform the heat of the batteries, in addition to the function to electrically connect the batteries, makes an exclusive radiator plate unnecessary and thereby reduces the total weight and the total number of components.

### BRIEF DESCRIPTION OF DRAWINGS

The invention will be described with reference to the accompanying drawings in which:

FIG. 1 is a perspective view illustrating a battery holder device with batteries held therein according to one embodiment of the invention;

FIG. 2 is a plan view illustrating the battery holder device of FIG. 1;

FIG. 3 is a perspective view illustrating a coupling bus bar;

FIG. 4 is a perspective view illustrating the state that one battery array group is connected with adjacent another battery array group by the coupling bus bar;

FIG. 5 is a diagram illustrating an electrical connection path to connect a plurality of batteries across adjacent battery array groups by means of coupling bus bars;

FIG. 6 is a perspective view illustrating a positive electrode bus bar;

FIG. 7 is a perspective view illustrating the state that a plurality of batteries in a battery array group are connected by means of the positive electrode bus bar:

FIG. 8 is a diagram illustrating an electrical connection path to connect a plurality of batteries in a battery array group by means of the positive electrode bus bar;

FIG. 9 is a perspective view illustrating a negative electrode bus bar;

FIG. 10 is a perspective view illustrating the state that a plurality of batteries in a battery array group are connected by means of the negative bus bar;

FIG. 11 is a diagram illustrating an electrical connection path to connect a plurality of batteries in a battery array group by means of the negative electrode bus bar; and

FIG. 12 is a diagram illustrating an electrical connection path to connect a plurality of batteries in battery array groups of the battery holder device.

### DESCRIPTION OF EMBODIMENTS

### (1) General Structure of Battery Holder Device

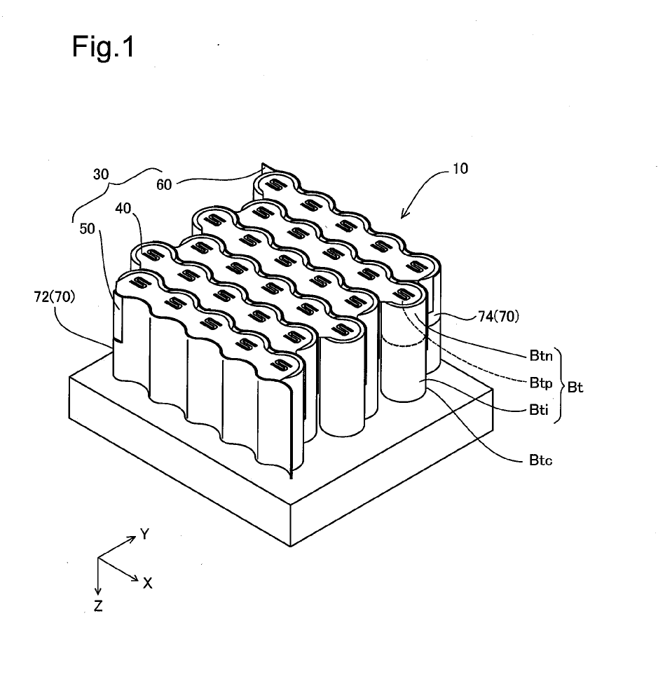

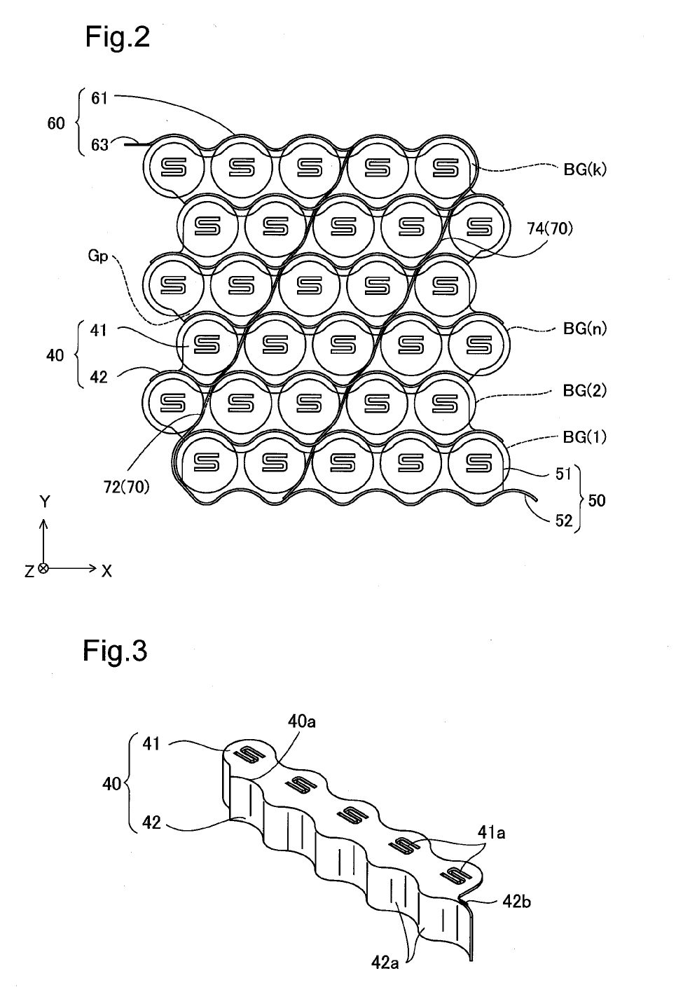

FIG. 1 is a perspective view illustrating a battery holder device 10 with batteries held therein according to one embodiment of the invention. FIG. 2 is a plan view illustrating the battery holder device 10 of FIG. 1. The battery holder device 10 is configured to support a plurality of batteries Bt and connect the respective batteries Bt by means of a bus bar 30. The batteries Bt are cylindrical general-purpose batteries and may be, for example, lithium ion batteries used as the power source for automobiles.

XYZ axes orthogonal to one another are also illustrated in FIG. 1. The X-axis direction is also called an array direction of batteries. The Y axis direction is a direction perpendicular to the array direction and is also called a row direction of batteries. The Z-axis direction is a direction parallel to the side faces of the batteries and is also called an axial direction of batteries.

As shown in FIG. 2, in the case that a plurality of batteries are arrayed in the X-axis direction, a combination of these batteries is specified as a battery array group. It is here assumed that battery array groups are arranged in k rows (wherein k is a natural number) in the Y-axis direction. In the description below, these battery array groups are sequentially expressed as BG(1), BG(2), . . . , BG(n), . . . BG(k) from the front side of illustration.

Referring to FIG. 1, each of the batteries Bt has a battery casing Btc in a cylindrical shape. A positive electrode terminal Btp is formed on an end face (upper face in the illustration) of the battery casing Btc. A negative electrode surface Btn is formed on the upper portion of the side face of the battery casing Btc. The remaining side face of the battery casing Btc other than the side face forming the negative electrode surface Btn forms an insulating side face Bti.

### (2) Structures of Respective Components

The bus bar 30 includes coupling bus bars 40, a positive electrode bus bar 50 and a negative electrode bus bar 60, which are respectively arranged on the top and on the side faces of the batteries Bt.

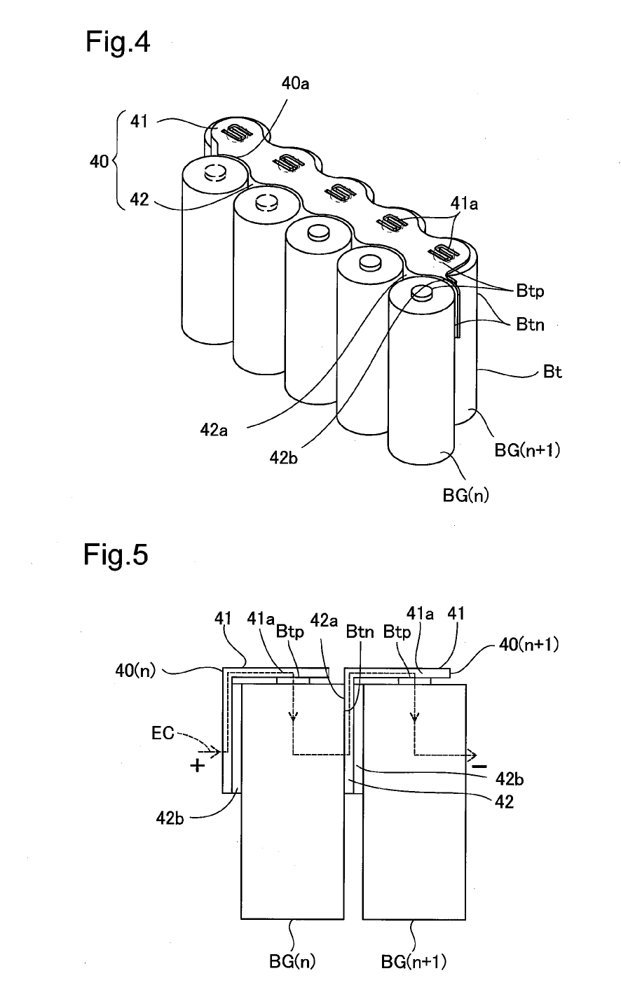

FIG. 3 is a perspective view illustrating the coupling bus bar 40. FIG. 4 is a diagram illustrating the state that one battery array group BG(n) is connected with adjacent another battery array group BG(n+1) by the coupling bus bar 40. Referring to FIG. 3, the coupling bus bar 40 is provided by press-forming a metal thin plate. The coupling bus bar 40 includes a positive electrode connection member 41 and a negative electrode connection member 42 and is bent at a right angle at a junction site 40a between the positive electrode connection member 41 and the negative electrode connection member 42. The positive electrode connection member 41 is a long thin plate extended in the array direction. A number of terminal strips 41a corresponding to the number of the batteries Bt are formed on the positive electrode connection member 41 at predetermined intervals in the array direction. Each of the terminal strips 41a is a portion connected to the positive electrode terminal Btp of the battery Bt and is provided as a cantilevered piece. The terminal strip 41a is deflected when being pressed by the positive electrode terminal Btp, so as to enhance the electrical connectivity. Each of the terminal strips 41a is connected with the positive electrode terminal Btp of the battery Bt, so that the positive electrode connection member 41 sequentially connects the positive electrode terminals Btp of the plurality of batteries Bt.

The negative electrode connection member 42 is a long corrugated thin plate extended in the array direction. A number of terminal surfaces 42a corresponding to the number of the batteries Bt are formed on the negative electrode connection member 42 at predetermined intervals in the array direction. Each of the terminal surfaces 42a is a portion connected to the negative electrode surface Btn of the battery Bt and is formed in a wavy shape to be in surface contact with the negative electrode surface Btn on the side face of the battery Bt. This enhances the electrical connectivity in contact with the negative electrode surface Btn. Each of the terminal surfaces 42a is connected with the negative electrode surface Btn of the battery Bt, so that the negative electrode connection member 42 sequentially connects the negative electrode surfaces Btn of the plurality of batteries Bt.

FIG. 5 is a diagram illustrating an electrical connection path to connect a plurality of batteries across adjacent battery array groups by means of coupling bus bars. The following describes the case that two battery array groups BG(n) and BG(n+1) are connected by means of coupling bus bars 40(n) and 40(n+1) with referring to FIG. 5. The coupling bus bar 40(n) is arranged on the top of the batteries Bt of the battery array group BG(n), and the coupling bus bar 40(n+1) is arranged on the top of the batteries Bt of the battery array group BG(n+1). The positive electrode connection member 41 of the coupling bus bar 40(n+1) is connected with the positive electrode terminals Btp of the batteries Bt of the battery array group BG(n+1). The positive electrode connection member 41 is integrated with the negative electrode connection member 42 and is thereby connected with the negative electrode connection member 42. The negative electrode connection member 42 is away from the negative electrode surfaces Btn of the battery array group BG(n+1) across an insulating coat layer 42b, so that the negative electrode connection member 42 is not electrically connected with the negative electrode surfaces Btn of the battery array group BG(n+1) but is connected with the negative electrode surfaces Btn of the batteries Bt of the adjacent battery array group BG(n). Additionally, the positive electrode terminals Btp of the batteries Bt of the battery array group BG(n) are connected with the positive electrode connection member 41 of the coupling bus bar 40(n). Accordingly, the battery array groups BG(n) and BG(n+1) are connected in series via the coupling bus bars 40(n) and 40(n+1) through an electrical connection path EC shown by the broken line.

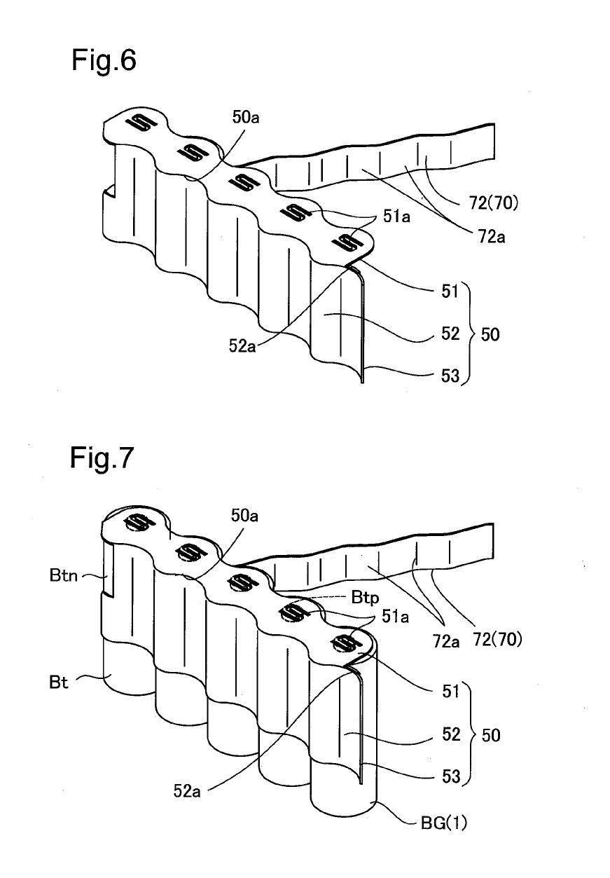

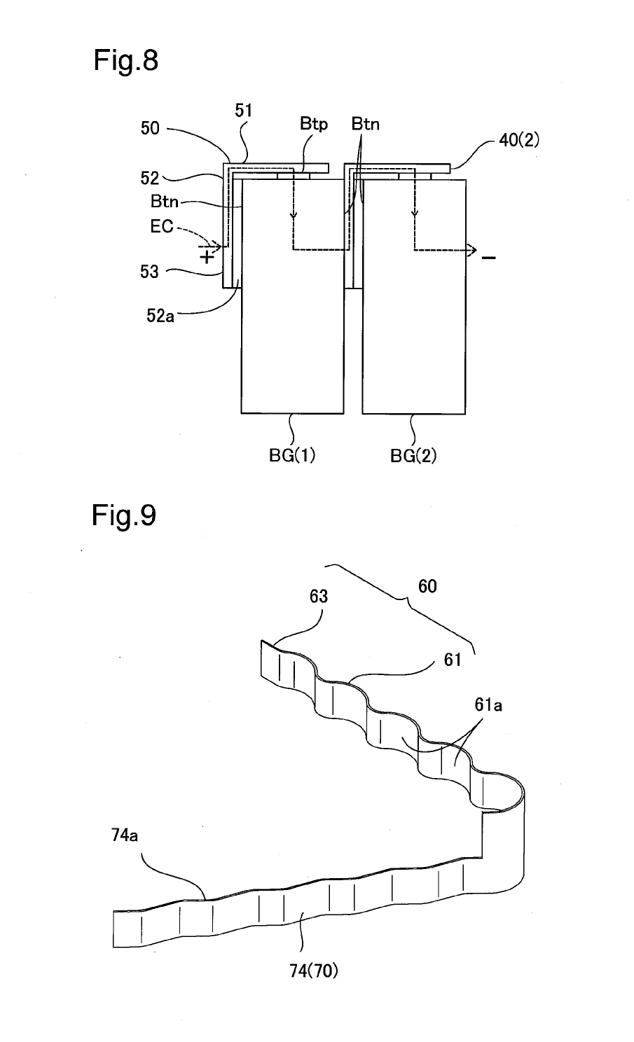

FIG. 6 is a perspective view illustrating the positive electrode bus bar 50. FIG. 7 is a perspective view illustrating the state that a plurality of batteries in a battery array group BG(1) are connected by means of the positive electrode bus bar 50. Referring to FIG. 6, the positive electrode bus bar 50 is provided by press-forming a metal thin plate. The positive electrode bus bar 50 includes a positive electrode connecting member 51, a heat transfer plate 52 and a positive electrode external terminal 53 and is bent at a right angle at a junction site 50a between the positive electrode connecting member 51 and the heat transfer plate 52. The positive electrode connecting member 51 is a long thin plate extended in the array direction. A number of terminal strips 51a corresponding to the number of batteries Bt are formed on the positive electrode connecting member 51 at predetermined intervals in the array direction. Each of the terminal strips 51a is a portion connected to the positive electrode terminal Btp of the battery Bt and is provided as a cantilevered piece. The terminal strip 51a is deflected when being pressed by the positive electrode terminal Btp, so as to enhance the electrical connectivity. Each of the terminal strips 51a is connected with the positive electrode terminal Btp of the battery Bt, so that the positive electrode connecting member 51 sequentially connects the positive electrode terminals Btp of the plurality of batteries Bt. The heat transfer plate 52 is a long corrugated thin plate extended in the array direction. The heat transfer plate 52 is away from the negative electrode surfaces Btn of the batteries Bt across an insulating coat layer 52a (FIG. 8) in the row direction, so as to have electrical insulation to the negative electrode surfaces Btn. The positive electrode external terminal 53 is an external terminal formed on an end of the positive electrode bus bar 50 to serve as a positive electrode of the entire battery holder device 10.

FIG. 8 is a diagram illustrating an electrical connection path to connect a plurality of batteries in a battery array group BG by means of the positive electrode bus bar 50. The positive electrode connecting member 51 of the positive electrode bus bar 50 is connected with the positive electrode terminals Btp of the batteries Bt in the battery array group BG(1). The positive electrode connecting member 51 is integrated with the heat transfer plate 52. The insulating coat layer 52a is, however, located between the heat transfer plate 52 and the negative electrode surface Btn of the battery array group BG(1), so that the heat transfer plate 52 is not electrically connected with the negative electrode surfaces Btn of the battery array group BG(1). Accordingly, the positive electrode bus bar 50 is connected the positive electrode terminals Btp in series through an electrical connection path EC shown by the broken line and serves as an external terminal at the location of the positive electrode external terminal 53.

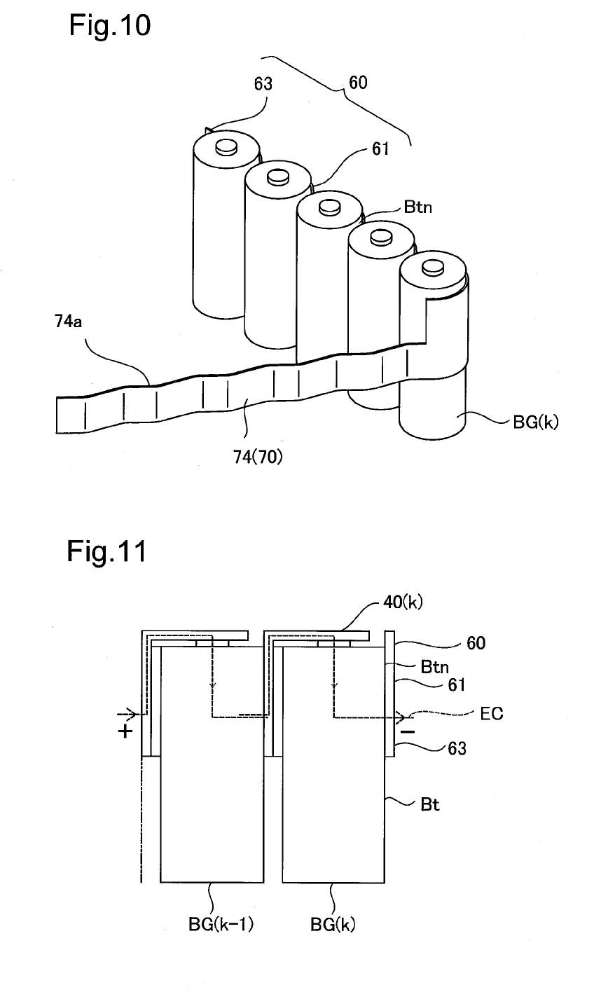

FIG. 9 is a perspective view illustrating the negative electrode bus bar 60. FIG. 10 is a diagram illustrating the state that a plurality of batteries in a battery array group BG(k) are connected by means of the negative bus bar 60. Referring to FIG. 9, the negative electrode bus bar 60 is provided by press-forming a metal thin plate and includes a negative electrode connecting member 61 and a negative electrode external terminal 63. The negative electrode connecting member 61 is a long corrugated thin plate extended in the array direction. A number of terminal surfaces 61a corresponding to the number of the batteries Bt are formed on the negative electrode connecting member 61 at predetermined intervals in the array direction. Each of the terminal surfaces 61a is a portion connected to the negative electrode surface Btn of the battery Bt and is formed in a wavy shape to be in surface contact with the negative electrode surface Btn on the side face of the battery Bt. This enhances the electrical connectivity in contact with the negative electrode surface Btn. Each of the terminal surfaces 61a is connected with the negative electrode surface Btn of the battery Bt, so that the negative electrode connecting member 61 sequentially connects the negative electrode surfaces Btn of the plurality of batteries Bt. The negative electrode external terminal 63 is an external terminal formed on an end of the negative electrode bus bar 60 to serve as a negative electrode of the entire battery holder device 10.

FIG. 11 is a diagram illustrating an electrical connection path to connect a plurality of batteries in a battery array group BG by means of the negative electrode bus bar 60. The negative electrode connecting member 61 of the negative electrode bus bar 60 is connected with the negative electrode surfaces Btn of the batteries Bt in the battery array group BG(k). Accordingly, the negative electrode bus bar 60 connects the batteries Bt in series through an electrical connection path EC shown by the broken line and serves as an external terminal at the location of the negative external terminal 63.

As shown in FIGS. 7 and 10, the positive electrode bus bar 50 and the negative electrode bus bar 60 are provided with thermal connecting members 70. The thermal connecting members 70 include a positive electrode-side thermal connecting member 72 (FIG. 7) and a negative electrode-side thermal connecting member 74 (FIG. 10). The positive electrode-side thermal connecting member 72 is extended from the lower portion at an end of the heat transfer plate 52 of the positive electrode bus bar 50. More specifically, the positive electrode-side thermal connecting member 72 has contact surfaces 72a formed in a sequential wavy shape to be in surface contact with the side faces of the respective batteries Bt, but is extended from the lower portion of the heat transfer plate 52 of the positive electrode bus bar 50 not to be in contact with the negative electrode surfaces Btn. The negative electrode-side thermal connecting member 74 is extended from an end of the negative electrode bus bar 60. More specifically, the negative electrode-side thermal connecting member 74 has contact surfaces 74a formed in a sequential wavy shape to be in surface contact with the side faces of the batteries Bt, but is extended from the lower portion of the negative bus bar 60 not to be in contact with the negative electrode surfaces Btn. As shown in FIG. 2, the positive electrode-side thermal connecting member 72 and the negative electrode-side thermal connecting member 74 are arranged to obliquely pass across the battery array groups BG and to be in contact with the side faces of the adjacent batteries Bt excluding the negative electrode surfaces Btn.

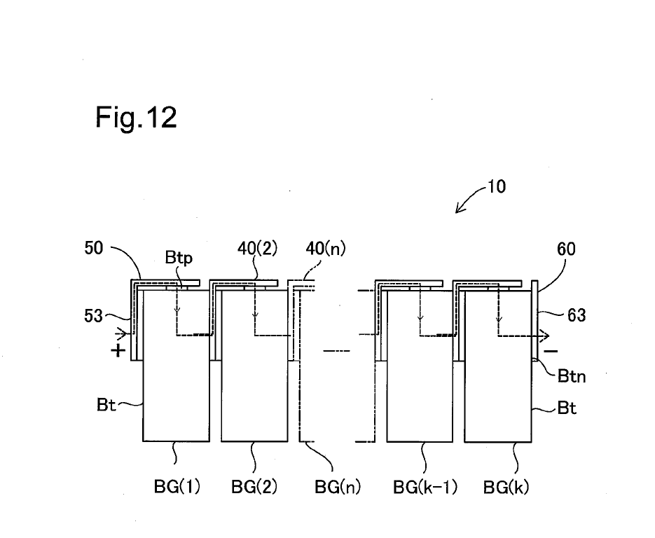

FIG. 12 is a diagram illustrating an electrical connection path to connect a plurality of batteries in battery array groups of the battery holder device. The wiring for the batteries in FIG. 12 is configured by connecting the electrical connection paths shown in FIGS. 8, 5 and 11 from the left side to the right side of the illustration. The positive electrode external terminal 53 of the positive electrode bus bar 50 is connected with the coupling bus bars 40 to the negative electrode external terminal 63 of the negative electrode bus bar 60, so as to connect the batteries Bt in a battery array group BG in parallel and sequentially connect the battery array groups BG in series.

### (3) Functions and Advantageous Effects of Battery Holder Device

As shown in FIGS. 4 and 5, the coupling bus bar 40 of the bus bar 30 is arranged across battery array groups, such as to sequentially connect the positive electrode terminals Btp of the batteries Bt in one battery array group, along with sequentially connecting the negative electrode surfaces Btn of another battery array group. A plurality of the coupling bus bars 40 arranged across a plurality of battery array groups accordingly connect the respective batteries Bt in a battery array group in parallel and connect the battery array groups in series. This arrangement simplifies the wiring operation for the plurality of batteries Bt.

As shown in FIGS. 4 and 5, the negative electrode connection member 42 of the coupling bus bar 40 sequentially connects the negative electrode surface Btn in each electrode array group, so as to transfer heat between the respective batteries Bt in the electrode array group and equalize the temperatures of the batteries Bt. As shown in FIGS. 10 and 11, the negative electrode connecting member 61 of the negative electrode bus bar 60 sequentially connects the negative electrode surface Btn in a battery array group, so as to transfer heat between the respective batteries Bt in the battery array group and equalize the temperatures of the batteries Bt. As shown in FIGS. 7 and 8, the heat transfer plate 52 of the positive electrode bus bar 50 is arranged across the insulating coat layer 52a on the side faces of the batteries Bt in the battery array group. This arrangement equalizes the temperatures of the respective batteries connected by means of the positive electrode bus bar 50 through the heat release from the side faces of the batteries Bt. The bus bar 30 accordingly serves to uniform the heat of the batteries Bt, thus preventing thermal deterioration of only part of the batteries Bt and extending the life of the batteries. The additional function of the bus bar 30 to uniform the heat of the batteries Bt, in addition to the function to electrically connect the batteries Bt, makes an exclusive radiator plate unnecessary and thereby reduces the total weight and the total number of components.

As shown in FIG. 3, the positive electrode connection member 41 and the negative electrode connection member 42 of the coupling bus bar 40 are formed by bending a metal thin plate in an L shape. This simplifies the structure and reduces the total number of components.

As shown in FIG. 5, the insulating coat layer 42b is provided between the negative electrode connection member 42 of the coupling bus bar 40 and the negative electrode surfaces Btn of the batteries Bt in an adjacent battery group array. This insulating coat layer 42b is in contact with the negative electrode surfaces Btn, thus efficiently cooling down the batteries Bt.

As shown in FIG. 3, the terminal surfaces 42a of the negative electrode connection member 42 of the coupling bus bar 40 are formed in the wavy shape. This increases the contact area with the side faces of the batteries Bt and has the enhanced electrical contact performance and excellent heat transfer performance. As shown in FIG. 10, the terminal surfaces 61a of the negative electrode connecting member 61 of the negative electrode bus bar 60 are also formed in the wavy shape. This increases the contact area with the side faces of the batteries Bt and has the enhanced electrical contact performance and excellent heat transfer performance.

As shown in FIG. 2, the thermal connecting members 70 are arranged to pass across the plurality of battery array groups and to be in contact with the side faces of the batteries Bt. The thermal connecting members 70 accordingly transfer heat across the plurality of battery array groups and equalize the temperatures of the batteries Bt. This arrangement equalizes the temperatures of the batteries Bt over the entire battery holder device 10, thus extending the life of the entire batteries.

The positive electrode-side thermal connecting member 72 (FIG. 7) and the negative electrode-side thermal connecting member 74 (FIG. 9) of the thermal connecting members 70 are respectively integrated with the positive electrode bus bar 50 and with the negative electrode bus bar 60. This arrangement reduces the total number of components.

### (4) Other Embodiments

The present invention is not limited to the embodiment, examples or modifications described above but may be implemented by various other configurations without departing from the scope of the invention.

The above embodiment describes the configuration of reducing the number of components by providing the positive electrode connection member 41 and the negative electrode connection member 42 formed by bending a metal thin plate in an L shape as shown in FIG. 3. This is, however, not restrictive, but the positive electrode connection member 41 and the negative electrode connection member 42 may be provided as separate members and connected by, for example, wiring. This increases the flexibility in arrangement of battery array groups.

In the coupling bus bar 40 of the embodiment, the negative electrode connection member 42 is provided with the insulating coat layer 42b so as to have electrical insulation to the negative electrode surfaces Btn as shown in FIG. 5. This is, however, not restrictive. The negative electrode connection member 42 may be provided with a sheet or a film made of an insulating material. The negative electrode connection member 42 may be away from the negative electrode surfaces Btn across a space.

In the above embodiment, the thermal connecting members 70 are integrated with the positive electrode bus bar 50 and with the negative electrode bus bar 60 as shown in FIGS. 6 and 10. This is, however, not restrictive. The thermal connecting members 70 may be provided separately from the positive electrode bus bar 50 and the negative electrode bus bar 60. In this application, the shapes of the thermal connecting members 70 are not limited by the shapes of the positive electrode bus bar 50 and the negative electrode bus bar 60. This simplifies manufacture.

The above embodiment describes the configuration that the plurality of batteries are placed in the equilateral triangular arrangement. This is, however, not restrictive, and the plurality of batteries may be placed in any of various arrangements, such as in a lattice-like arrangement or in an arrangement that minimizes the interval between the batteries for the purpose of space-saving.

The batteries described in the above embodiment are in a cylindrical shape. This is, however, not restrictive, and the invention may be applied to other batteries, such as rectangular batteries and button batteries, in such a range that does not damage the functions and the advantageous effects of the invention.

According to another aspect, there is provided the battery device, in which the coupling bus bar has the positive electrode connection member and the negative electrode connection member formed by bending a plate-like member in an L shape.

According to another aspect, there is provided the battery device, in which the negative electrode connection member is away from the negative electrode surfaces in the one battery array group across an insulating coat layer, so as to have electrical insulation to the negative electrode surfaces in the one battery array group.

According to another aspect, there is provided the battery device, in which the negative electrode connection member has a terminal surface that is in contact with the negative electrode surface of the battery.

According to another aspect, there is provided the battery device, in which the negative electrode connection member is formed as a single plate-like member to sequentially connect the respective negative electrode surfaces of the plurality of batteries.

According to another aspect, there is provided the battery device, in which the battery has a cylindrical side face, and the terminal surface has a curved surface that is in surface contact with the cylindrical side face of the battery.

According to another aspect, there is provided the battery device, in which the positive electrode bus bar has a heat transfer plate integrally formed with the positive electrode connecting member, the heat transfer plate being away from the specific negative electrode surfaces in the specific battery array group across an insulating coat layer, so as to have electrical insulation to the specific negative electrode surfaces in the specific battery array group.

According to another aspect, there is provided the battery device, in which the battery has a cylindrical side face, and the heat transfer plate has a curved surface arranged to be away from the cylindrical side face of the battery across a predetermined space.

According to another aspect, there is provided the battery device, in which the battery has an electrically insulating side face without the negative electrode surface. The battery device further comprises a thermal connecting member arranged to pass across the batteries in the plurality of battery array groups and configured to have contact surfaces that are in connect with the insulating side face.

According to another aspect, there is provided the battery device, in which the thermal connecting member is coupled with at least one of the positive electrode bus bar and the negative electrode bus bar.

What is claimed is:

1. A battery device provided with a bus bar, in which a plurality of battery array groups are arranged in parallel to one another, and each of the battery array groups includes a plurality of batteries arranged in an array, wherein each of the batteries has a positive electrode terminal provided on an end face of a battery casing and a negative electrode surface provided on a side face of the battery casing which is extended from an outer periphery of the end face of the battery casing,
wherein the bus bar comprises:
a coupling bus bar including: a positive electrode connection member arranged to connect the positive electrode terminals of the respective batteries included in one battery array group; and a negative electrode connection member arranged to connect the negative electrode surfaces of the respective batteries included in another battery array group adjacent to the one battery array group, wherein the positive electrode connection member is electrically connected with the negative electrode connection member;
a positive electrode bus bar including: a positive electrode connecting member arranged to connect specific positive electrode terminals in a specific battery array group, which are not connected by the coupling bus bar; and an external terminal connected with the positive electrode connecting member; and
a negative electrode bus bar including: a negative electrode connecting member arranged to connect specific negative electrode surfaces in a specific battery array group, which are not connected by the coupling bus bar; and an external terminal connected with the negative electrode connecting member.

2. The battery device according to claim 1, wherein the coupling bus bar has the positive electrode connection member and the negative electrode connection member formed by bending a plate-like member in an L shape.

3. The battery device according to claim 1, wherein the negative electrode connection member is away from the negative electrode surfaces in the one battery array group across an insulating coat layer, so as to have electrical insulation to the negative electrode surfaces in the one battery array group.

4. The battery device according to claim 1, wherein the negative electrode connection member has a terminal surface that is in contact with the negative electrode surface of the battery.

5. The battery device according to claim 4, wherein the negative electrode connection member is formed as a single plate-like member to sequentially connect the respective negative electrode surfaces of the plurality of batteries.

6. The battery device according to claim 5, wherein the battery has a cylindrical side face, and the terminal surface has a curved surface that is in surface contact with the cylindrical side face of the battery.

7. The battery device according to claim 6, wherein the positive electrode bus bar has a heat transfer plate integrally formed with the positive electrode connecting member, the heat transfer plate being away from the specific negative electrode surfaces in the specific battery array group across an insulating coat layer, so as to have electrical insulation to the specific negative electrode surfaces in the specific battery array group.

8. The battery device according to claim 7, wherein the battery has a cylindrical side face, and the heat transfer plate has a curved surface arranged to be away from the cylindrical side face of the battery across a predetermined space.

9. The battery device according to claims 1, wherein the battery has an electrically insulating side face without the negative electrode surface, the battery device further comprising a thermal connecting member arranged to pass across the batteries in the plurality of battery array groups and configured to have contact surfaces that are in connect with the insulating side face.

10. The battery device according to claim 9, wherein the thermal connecting member is coupled with at least one of the positive electrode bus bar and the negative electrode bus bar.
